(19) United States
(12) Patent Application Publication
(10) Pub. No.: US 2004/0129523 A1
(43) Pub. Date: Jul. 8, 2004

(54) Electric cable storage device

(75) Inventor: Tat-Kwong Cheung, Kowloon (CN)

Correspondence Address: BURNS DOANE SWECKER & MATHIS L L P, POST OFFICE BOX 1404, ALEXANDRIA, VA, 22313-1404, US

(73) Assignee: JIM FUNG ELECTRICAL COMPANY LTD., Kowloon (CN)

(21) Appl. No.: 10/702,728

(22) Filed: Nov. 7, 2003

(30) Foreign Application Priority Data
Jan. 7, 2003 (HK) 03100188.9

(51) Int. Cl. H02G 11/00

(52) U.S. Cl. 191/12.2 R

(57) ABSTRACT

An electrical cable storage device, such as a cable reel, including a cable receptacle and a length of flexible electrical cable, the cable receptacle includes a core portion around which the length of flexible electrical cable can be wound into a plurality of stacked cable layers, the electrical cable includes an outer insulated layer which surrounds one or more electrical conductors and spacing means, the spacing means are adapted to co-operatively form air space between adjacent layers of the length of flexible electrical cable when the flexible cable is being wound on the core portion, the air space being adapted to alleviate the building up of adverse heat on the wound flexible cable due to current flowing through the flexible cable.

### FIELD OF THE INVENTION

This invention relates to electric cable storage devices and, more particularly, to electric cable storage devices which are more commonly known as cable extenders. More specifically, although of course not solely limited thereto, this invention relates to cable reels having a core or yoke portion around which a length of flexible electric cable can be wound for storage and from which the stored cable can be dispensed. This invention also relates to electrical cables with ventilating spacers as well as electrical devices and apparatus including a cable reel.

### BACKGROUND OF THE INVENTION

Electric power cables (or electric cables in short) are generally used for connection between an electric power source and electrical power consuming apparatus or load, such as lighting equipment, power tools, domestic appliances and the like, so that electric power can flow from the power source to the power consuming apparatus for operation.

A typical electric cable includes an insulated outer layer surrounding one or more insulated electric conductors. When an electric current flows through an electric conductor, heat energy proportional to the resistance of the electric conductor and the square of the instantaneous current flowing through the conductor will be generated. In many applications, a length of electric cable is wound into a plurality of contiguous cable windings and a plurality of closely stacked cable layers. For example, electric power cables are typically stored in rolls and are wound on a rigid, and usually cylindrical, core. The cables are typically used in the unwound form for temporary connection before a more permanent connection is made. Extension cords and cable reels are other examples in which electric cables are frequently stored in a closely packed form.

Extension cords, cable reels and the like are frequently used for provisional or temporary connection between an electric power source and a mobile or relocatable electrical load, appliance or apparatus. Typically, an extension cord or a cable reel includes a length of flexible electric cable so that a variable length of electrical connection can be made available when required. To minimize the length of loose, strayed or unrestrained cable portion between the cord reel and the load terminals, users tend to wind or rewind the loose or excessive portion of the electric cable on the cord reel and arranged into a plurality of closely stacked cable layers each comprising a plurality of usually concentric cable windings. When electric current flows through the electric cable, heat will be generated by the flow of the electric current due to the resistance of the electrical conductors. Since the electrical cords or cables are typically surrounded by an outer insulated layer, for example, a PVC layer, which is usually both thermally and electrically insulating, the adversely generated heat will be trapped and accumulated in the insulated layer as well as in the small spacing between the adjacently stacked cable windings and the adjacently stacked cable layers. When a sufficiently high current, for example, a current at around the current rating of the cable for operating power tools or heavy loads, flows through the closely packed multiple cable windings for a sufficiently long time, the accumulated heat may be sufficient to cause melting down of the insulated layer, thereby causing fire, electrical and other hazards as well as possible personal injuries.

Thus, commonly available cable reels and like devices with a length of retrievable flexible power cable are always accompanied with a warning that the wound flexible cord should be fully released when in use to alleviate potential hazards or as an attempt to minimize the liability of the suppliers or manufacturers of the devices. For the same or similar reasons, simple extension cords, which usually comprise a length of flexible electric cable with terminating connectors, such as, for example, a plug and a socket, at both ends are frequently used while a substantial portion of the cable is still being wound on the separable cable wheel, contrary to the safety recommendations. In fact, many safety laboratories or organizations recommended against the packaged sale of extension cords and cable wheels. However, it is not unknown that flexible extension cords and rigid cable wheels, yokes or cores, which are specifically designed to receive the flexible extension cords, are commonly available side by side or in the vicinity in hardware shops or outlets so that a user will be induced to purchase the flexible cables and the separate winding wheels for storing the cable to alleviate product liability claims. Hence, the state of affairs in relation to such extendable cable storage devices is non-satisfactory and there are hitherto no effective measures to prevent users from improperly using such extension cords or cable reels.

Thus, it will be highly desirable if there can be made available electric storage cable devices or apparatus which alleviate the known shortcomings of the commonly available electric cable storage devices and apparatus such as the conventional types of extension cords or cable reels. In particular, it will be highly beneficial if electric cable storage devices of the aforementioned types or, broadly speaking, electrical cable storing means, can be used safely even if a substantial or significant portion is still being stored in the device or means. In providing such improved electric cable devices or apparatus, it will be highly beneficial if such improved devices and apparatus can be made available without undue complexity or requiring substantial modifications to conventional devices and apparatus so that the improved devices and apparatus can be easily operated and available at a reasonable cost. In addition, as electrical cable storage devices are commonly used in conjunction with many electrical apparatus or appliances, it will be desirable to incorporate such improved cable storage devices with such electrical apparatus or appliances.

### OBJECT OF THE INVENTION

Thus, it is an object of the present invention to provide electric cable storage devices or apparatus, including extension cords and cable reels, which serve the purposes of such conventional devices while alleviating the afore-mentioned shortcomings. it is also an object of the present invention to provide improved electrical devices and apparatus which alleviate the afore-mentioned shortcomings of conventional electrical devices and apparatus without requiring unduly complicated modifications or accessories so that the improved devices and apparatus can be as easily operated and utilized as conventional devices.

More specifically, it is an object of the present invention to provide electric cable devices with a cable storage means which can operate with a reasonable degree of safety even when a substantial or significant length of power cable is still stored in or wound on the device. As can be appreciated from the description below, the present objectives are at least partly fulfilled by utilizing an improved electric cable. Therefore, it is also an object of the present invention to provide an improved design of electric cables.

At a minimum, it is an object of the present invention to provide the public with a useful choice of improved electric cables and electrical cable devices and apparatus, including extension cords and cable reels. Of course, the above objects are each to be read disjunctively with the object of at least providing the public with a useful choice.

### SUMMARY OF THE INVENTION

According to the present invention, there is provided an electrical cable device including a cable receptacle and a length of flexible electrical cable, said cable receptacle includes a core portion around which said length of flexible electrical cable can be wound into a plurality of stacked cable layers, said electrical cable includes an outer insulated layer which surrounds one or more electrical conductors and spacing means, said spacing means are adapted to co-operatively form air space between adjacent layers of said length of flexible electrical cable when said flexible cable is being wound on said core portion, said air space being adapted to alleviate the building up of adverse heat on the wound flexible cable due to current flowing through said flexible cable.

According to a preferred embodiment of the present invention, there is provided an electrical cable device including a cable receptacle and a length of flexible electrical cable, said cable receptacle includes a core portion around which said length of flexible electrical cable can be wound into a plurality of stacked cable layers, a plurality of ventilating air channels are formed between adjacent layers of said flexible cable when said flexible cable is wound around said core portion in the normal manner, said ventilating air channels being generally transversal to the direction of winding of said flexible electrical cable.

Although the spacing means can be in many different shapes or forms, the spacing means of a preferred example include generally helical or spiral protrusions formed on or attached to or about the outer surface of said outer insulated layer. In a preferred embodiment, the spacing means curl like a snake and coil helically or spirally along the flexible cable.

The helical or spiral protrusions of the spacing means being integrally formed or moulded with the outer insulated layer of the flexible cable. Such integral moulding will ensure the spacing means to stay in position and for easy manufacturing.

Preferably, said spacing means include convoluted protrusions formed on the outer surface of said outer insulated layer.

Preferably, said convoluted protrusions being integrally moulded or formed on said outer surface of said outer insulated layer.

Preferably, said spacing means include a plurality of ring-shaped protrusions distributed generally along the length of said flexible electrical cable.

Preferably, said cable receptacle being rotatable about a supporting means, said cable receptacle being rotatable in one direction to release said length of flexible cable and in another direction to retrieve said flexible cable.

Preferably, said spacing means co-operatively define with adjacent layers of said flexible electrical cable a plurality of ventilating air channels when said electrical wire is wound on said core portion of said receptacle, said ventilating air channels being disposed to direct hot air to exit from said wound layers of flexible cable to the outside.

Preferably, said ventilating channel includes an exit aperture between adjacent layers of stacked cable, said air channel and said aperture being disposed so that hot air exiting from said device will emerge at an orientation which is generally transverse to the length of said flexible electrical cable.

Preferably, a plurality of cable windings are formed on a cable layer, said spacing means collectively form a plurality of ventilating air channels between two adjacent layers of said flexible electrical cable when said cable is wound in the normal manner on said core portion of said receptacle.

Preferably, said ventilating channels on the same cable layer extend transversally between the outermost windings.

Preferably, said plurality of ventilating air channels on the same cable layer generally extend transversal to the length of said cable and are distributed along the perimeter of said same cable layer.

Preferably, said ventilating air channels are co-operatively defined by the spacing means disposed on adjacent layers of said flexible electrical cable.

Preferably, said core portion includes a generally cylindrical winding surface around which said length of flexible electrical cable can be wound into a plurality of generally circular stacked cable layers.

Preferably, said receptacle further includes a pair of guarding walls disposed on the partial ends of said cylindrical winding surface.

Preferably, said receptacle being rotatably mounted on a supporting means.

Preferably, an electrical plug and an electrical pocket are connected to the ends of said flexible cable.

Preferably, either said electrical plug or said electrical socket is mounted on said rotatable receptacle.

According to another aspect of the present invention, there is provided an electrical cable including an outer insulated layer, said outer insulated layer surrounds one or more insulated conductors and includes spacing means, said spacing means being adapted to co-operatively form air space between adjacent layers of said length of flexible electrical cable when said cable is wound into a plurality layers of stacked cable windings, said air space being adapted to alleviate the building up of adverse heat on the stacked cable windings due to current flowing through said cable.

Preferably, said helical or spiral spacing means being moulded or integrally formed on said outer insulated layer.

According generally to the preferred embodiments of the present invention, said spacing means include generally helical, spiral or convoluted protrusions formed on the outer surface of said outer insulated layer.

Preferably, the pitch of said spacing means being about 20-25 mm.

Broadly speaking, there are also provided in the present invention electrical apparatus including a cable device with any one of aforesaid characteristics.

### BRIEF DESCRIPTION OF THE DRAWINGS

Preferred embodiments of the present invention will be explained in more detail by way of example and with reference to the accompanying drawings, in which:

FIG. 1 is a perspective view from one side and the front of a first preferred embodiment of the present invention showing a cable reel;

FIG. 1A is the perspective view of FIG. 1 with one of the lateral guard 15 removed,

FIG. 2 is a perspective view showing the other side and rear of the cable reel of FIG. 1;

FIG. 3 shows an exploded view of the cable reel of FIGS. 1 and 2;

FIG. 4A is a perspective view showing the cable receptacle of FIGS. 1 and 2 mounted on the base unit of the cable reel;

FIG. 4B is an exploded view of the sub-assembly of FIG. 4A;

FIG. 5A shows an exploded view from one side of the cable receptacle of FIG. 4A;

FIG. 5B is a perspective of the exploded cable receptacle of FIG. 5A viewed from the other side;

FIG. 5C is a perspective view of the cable receptacle of FIGS. 5A and 5B;

FIG. 6A is a perspective view showing a portion of a flexible electric cable of a first preferred embodiment of the present invention and used in the cable device of FIG. 1 together with an electrical terminal connector;

FIG. 6B is a cross-sectional view of the portion of the flexible electric cable of FIG. 6A taken across the section A-A;

FIG. 6C shows a portion of an example of a flexible electrical cable suitable for use in a 15-m cable reel;

FIG. 6D is a cross-sectional view of the portion of the flexible electric cable of FIG. 6C;

FIG. 7A is a perspective view showing a portion of a flexible electric cable of a second preferred embodiment of the present invention and used in the cable device of FIG. 1 together with an electrical terminal connector;

FIG. 7B is a cross-sectional view of the portion of the flexible electric cable of FIG. 7A taken across the section B-B;

FIG. 8A shows a perspective view of a portion of the third preferred embodiment of flexible electric cable of the present invention;

FIG. 8B shows a perspective view of a portion of the fourth preferred embodiment of flexible electric cable of the present invention; and

FIG. 9 shows a preferred embodiment of an extension cord of the present invention incorporating a length of a flexible electric cable of a first preferred embodiment of the present invention.

### DETAILED DESCRIPTION OF PREFERRED EMBODIMENTS

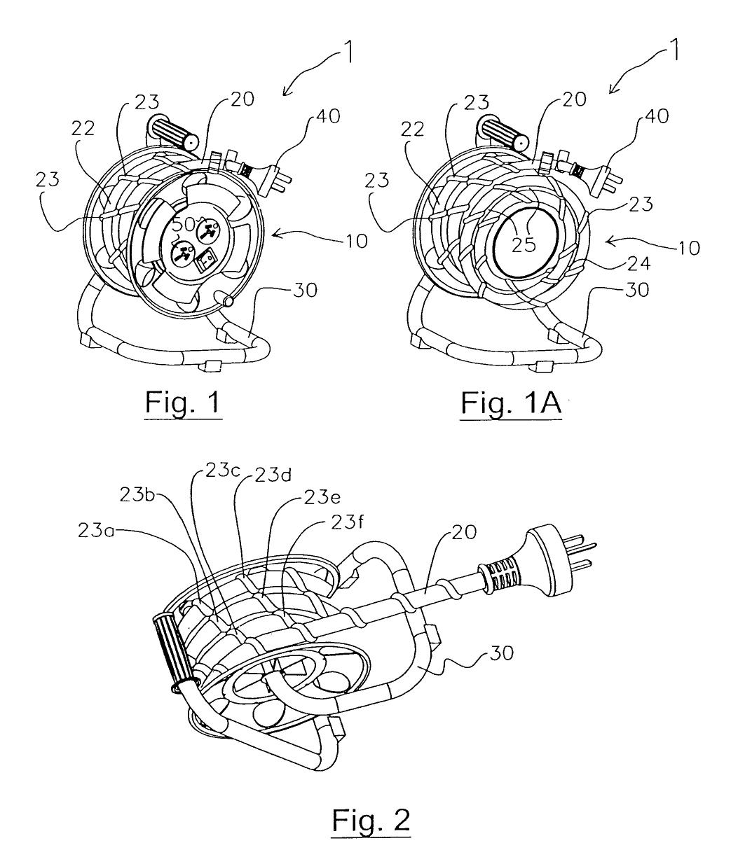

Referring firstly to FIGS. 1-3, there is shown a preferred embodiment of the present invention of an electric cable storage device I illustrated by way of an example of a cable reel. The electric cable storage device 1 includes a cable receptacle 10, a length of flexible electric cable 20, a base unit 30, an electric plug 40 connected to one end of the flexible electric cable 20 as an electrical terminating device, two sockets 50 connected to the other end of the flexible electrical cable 20 as another electrical terminating device and a switch 60 for controlling the electrical connection between the sockets 50 and the electric cable 20.

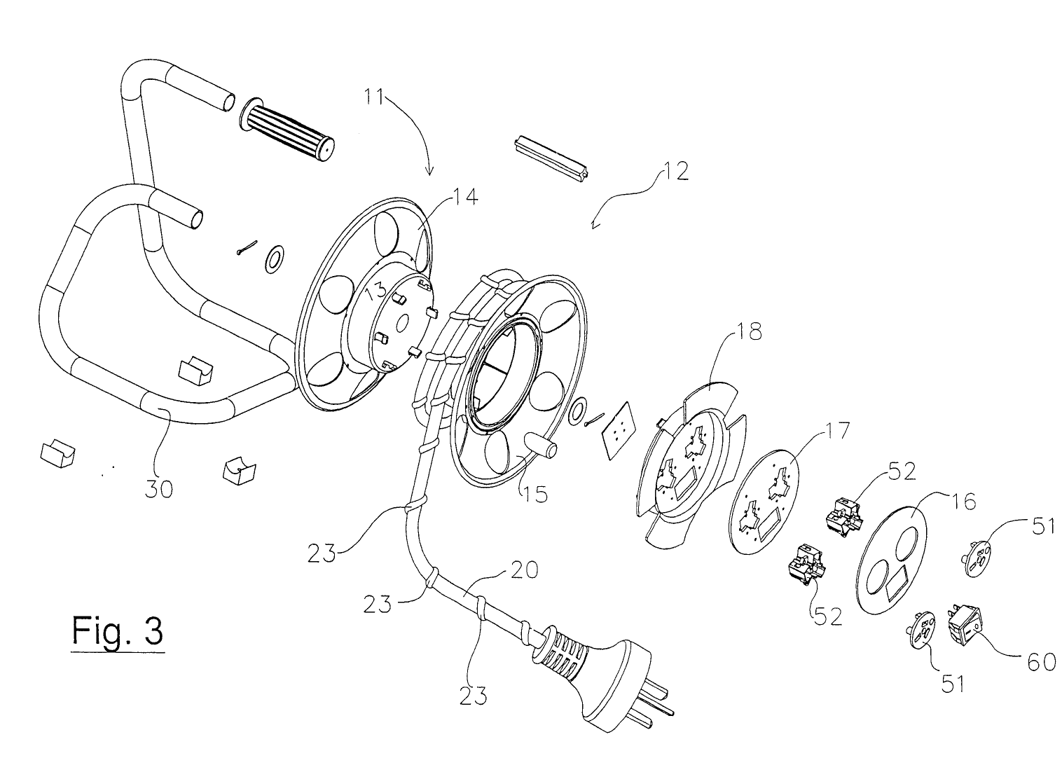

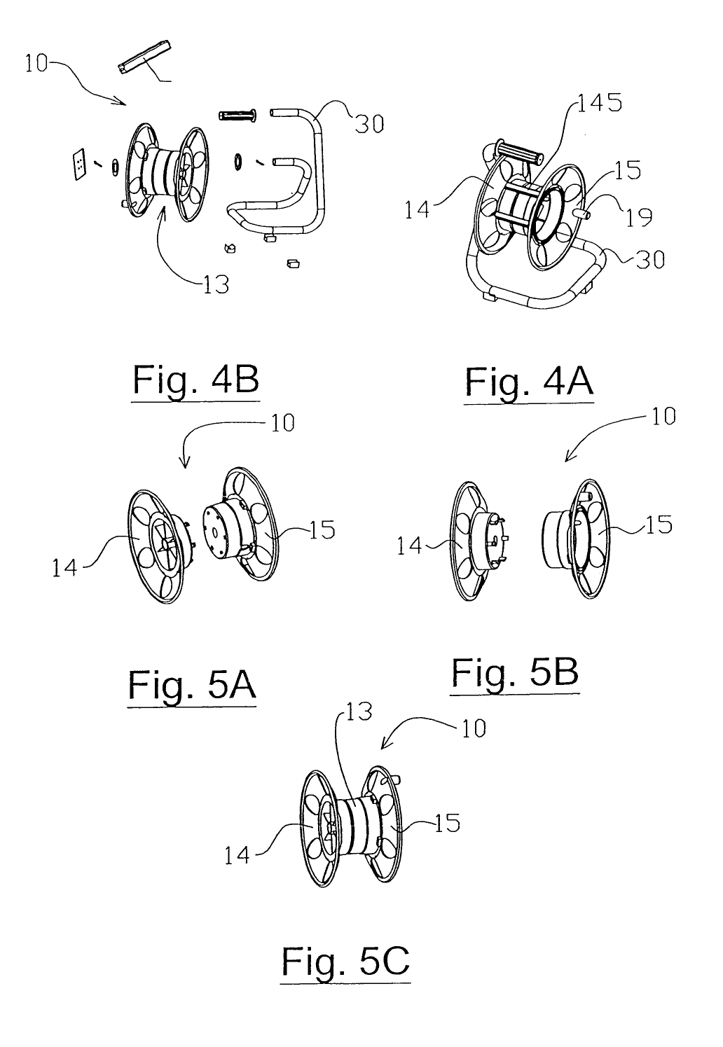

Referring to FIGS. 3-5C, the cable holder or cable receptacle 10 includes a first lateral member 11 and a second lateral member 12 which, when assembled together, define a core portion 13, a first lateral guard 14 and a second lateral guard 15. The sockets 50, each comprising a first 51 and a second 52 part, and the switch 60 are mounted on a first side panel 16. The sub-assembly comprising a first side panel 16, sockets 50 and the switch 60 are then mounted on a second side panel 17 which is in turn mounted on a third, teethed, panel 18. The sub-assembly including the third panel 18 and the switch and sockets are then mounted onto one of the lateral members 11, 12.

To provide electrical connection between the two ends of the flexible cable 20, the terminals of the conductors at one end of the flexible cable 20 are connected to the sockets 50 via the switch 60 as a convenient example. The core portion is generally dimensioned so that the length of the flexible electric cable 20 can be stored by winding into a plurality of stacked cable of layers around the core portion 13 with a plurality of cable windings distributed on each cable layer. In general, the radial dimension of the first 14 and the second side guards 15 are designed so that when the cable is fully wound on the core portion, the height or thickness of the wound flexible cable is about the same as or slightly lower than that of the side guards extending radially from the perimeter of the core portion 13. While the core portion and the side guards are generally circular, it will of course be appreciated that other shapes can also be used.

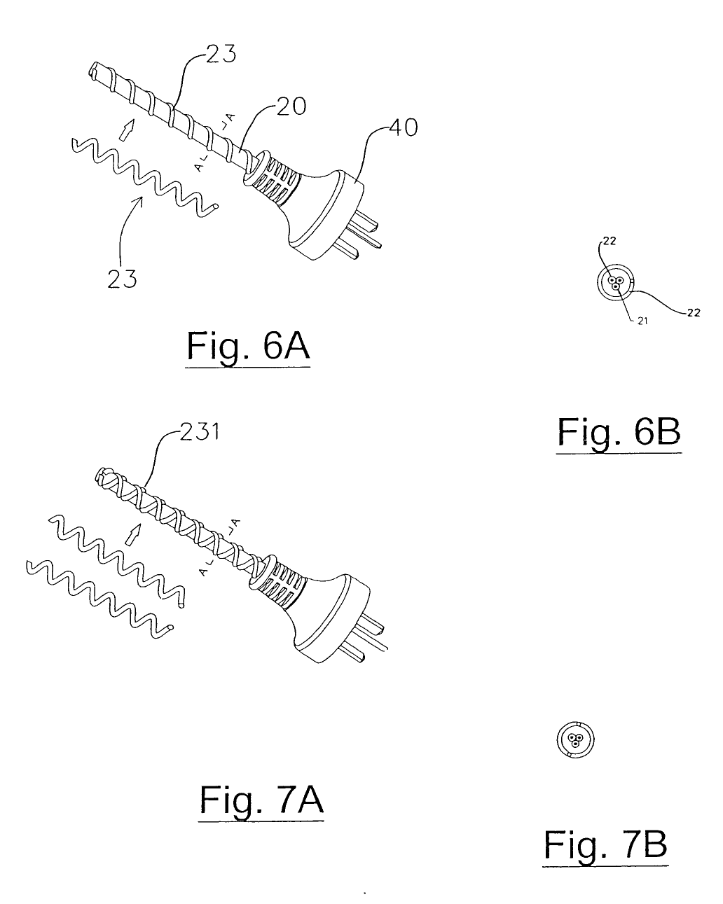

Referring also to FIGS. 6A and 6B, the electrical cable 20 includes a plurality of insulated conductors 21 which are further surrounded by an insulated outer layer 22. The insulated outer layer usually includes a plastic layer which is made, for example, of PVC or other generally flexible plastic or insulating materials. To enable electrical connections to be made with the power source, an electrical terminating device, such as an electric plug 40, is connected to the end of the electric cable 20 not already connected to the socket 50.

As shown in FIGS. 1, 1A, 2 and 6A, spacing means are formed on the electric cable 20. The spacing means 23 are disposed on the outer insulated layer 22 of the electric cable 20 so that air space will be co-operatively formed between adjacent portions of the electric cable when the cable is closely wound around the core portion 13. In the present preferred embodiment, the spacing means include spiral or helical protrusions formed on the outer surface of the outer insulated layer 22. When a length of the flexible electric cable 20 is wound on the core portion 13, the electric cable will be wound into a plurality of cable windings to form a cable layer. When a cable layer has been filled with cable windings, the cable will be wound into the next cable layer and so forth. The spacing means which are distributed on the outer insulated layer 22 will cooperate with the closely packed adjacent cable windings to provide additional insulating air space 24. With the additional air space, it will be appreciated that the building up of adverse heat between adjacent cable windings during passage of an electric current will be generally retarded, since it is known that air space is a good thermal insulator.

Furthermore, the spacing means are generally configured so that, when the electric cable is closely wound around the core portion 13, a plurality of ventilating air channels 25 are cooperatively formed between the adjacently disposed portion of the spacing means, as shown more particularly by the features 23a to 23f in FIG. 2. These ventilating air channels, as defined, for example, by the two adjacent rows of spacing means 23a-c and 23d-f and when cooperating with the next stacked cable layer, provide a through passageway so that hot air generated by the passage of electric current through the electric cable 20 can be guided away from the cable windings. Hence, the additional air space can also provide ventilating or heat dissipating effects.

It will be appreciated from the Figures that the ventilating air channels 24 are generally formed at an angle, and preferably disposed in the orientation which is substantially transversal, with respect to the length of the electric cable 20. With the disposition of ventilating channels which are non-parallel to the length of the cable 20, hot air to be dissipated can be effectively guided away from the cable device 1. It will be appreciated that the hot air more preferably (although not essentially) travels along the axial or transversal direction when exiting from the cable windings for optimal heat dissipation. In this connection, the terms “transversal” or “axial” direction mean the direction which is generally perpendicular to the winding plane of the electric cable. Generally speaking, this “transversal” or “axial” direction in this description means a direction which is perpendicular to the longitudinal orientation of the flexible cable 20.

In the present specific embodiment, the spacing means 23 are formed by a continuous length of helical or spiral protrusions on the outer insulated layer 22. The helical or spiral protrusions are adapted with an appropriate curvature so that when the cable is wound about the core portion 13 in the ordinary manner, the collection of the spacing means 23a-f define the sides of the ventilating air channels. The use of spacers or spacing protrusions which are generally convoluted (i.e., helical, spiral, coiled or generally twisted) about the insulated cable surface advantageously maintain a useful spacing separation between the insulating outer skins of the adjacent windings of the cable and therefore provides good insulating effect as well as enhancing heat disposing ventilation.

In this example, the curvature of the helical or spiral protrusion is generally constant throughout the length of the cable and the pitch of adjacent or neighbouring spacing means is generally constant. However, it will be appreciated that the curvature or the pitch can be gradually changing to accommodate for the change of the winding curvature as the windings expand from the core towards the outside. As can be seen from FIGS. 1 and 2, these ventilating air channels are distributed around the parameter of the core windings and can therefore provide a reasonably effective heat ventilation for the cable windings. In the present embodiments, the spacing means have an equal pitch or are spaced apart at generally the same separation distance throughout the effective length of the cable, this helps to define regular air ventilating channels. Furthermore, it would be appreciated that the spacing means need not be formed continuously and can be distributed at discrete intervals or even irregularly.

Referring to the drawings, it will be noted that the plurality of ventilating air channels distributed along the flexible electric cable are generally parallel to each other. By distributing the ventilating air channels between the stacked cable layers, the adverse heat generated by current passage through the conductors can be effectively guided away from the interior of the cable windings, thereby alleviating the risk of thermal melt-down before excessive heat is built up in the ordinary use of the electric cable device 1. Furthermore, the increased air space between the adjacent cable layers also helps to retard the rate of building-up of adverse thermal energy.

In the present specific example, the cable receptacle 10 is rotatably received on the base unit 30 so that the length of the flexible cable can be retrieved onto the cable receptacle 10 by rotating the cable receptacle in one direction and released by rotating in the other direction. To facilitate easy cable retrieval and release, a handle 19 including an axially extending hand piece is disposed on the outer surface of the lateral member 15 for rotation of the cable receptacle 10.

In the present specific example, the core portion 13 includes a generally cylindrical winding surface with a plurality of axially extending and free-running rollers 145 distributed around the outer circumference of the core portion 13 to provide smooth cable release and retrieval. In this preferred embodiment, the effective inner layer winding diameter of the first cable-winding layer is about 15 cm. and the effective winding width is approximately equal to 9 cm. The flexible electric cable used in the first preferred embodiment is generally equivalent to the standard type cable commonly identified as cable type HO5VV-3G1.25m and rated at 13A, 250V, except for the spacing means. The diameter of the outer insulated layer of this cable is approximate 8.6 mm. with the height of the protrusion of the spacing means being approximately equal to 1.5mm to 2mm. In the first winding layer, there are 6 cable windings on each layer and in the subsequent layers, there are about 7 windings in each cabling layer. There are a total of 4 cable winding layers to accommodate the 30 meters of cable.

The following table sets out examples of the various relationship between the diameter of outer insulator, the diameter of the un-insulated conductor and the length of the flexible electric cable at 10A, 250V rating for the present specific design.

TABLE 1
Cable: Insulated Outer Layer Diameter = 8.6 mm.
Conductor Diameter = 1 mm.

| Cable Length (m) | Height of Protrusion (mm) |
|---|---|
| 15 | 2.5 |
| 20 | 3.0 |
| 25 | 3.5 |

As a comparison, a cable reel including a length of the above standard-type electric cable without spacing means when operated as 13A, 250V at an ambient room temperature of 25° C. reaches 177° C. in four hours. This high temperature is sufficient to melt the PVC insulated outer layer. On the other hand, the cable reel of FIGS. 1 and 2 carrying the same length of the same type of cable but provided with the spacing means has a temperature of only 92° C. after six hours of continuous operation under the same electrical conditions. It will be noted the internal core winding temperature of this improved device is almost 85° C. lower than conventional cable reels.

In another example, a cable reel includes 15 meter of a flexible cable of φ7.8mm, for example, of standard type HO5W-F3G1.0. Referring to FIGS. 6C and 6D, the outer insulated skin of the cable has a diameter of 7.8 mm with three gauge 32/0.2 insulated copper conductors. Each of the gauge 32/0.2 copper conductors is insulated and has an outer diameter of 2.5 mm including the insulator. The spacing means comprises a cylindrical insulator which is attached to the outer insulator and spirals along the φ7.8 mm diameter outer insulator to form a helical band or snake. The helical snake formed by the cylindrical spacing means has a pitch of about 60 to 65 mm and the diameter of the cylindrical spacing means is advantageously between 4 mm and 5.5 mm. Of course, the helical band may have a non-cylindrical cross-section such as square, rectangular, or the shapes. It will be appreciated that a larger height or diameter of the spacing means increases the effective spacing between the copper conductors and is therefore beneficial for enhanced heat dissipation.

Hence, the above provide examples of flexible electrical cables with spacing means adapted for enhanced heat dissipation or enhanced ventilation when closely stacked together.

Referring to FIGS. 7A and 7B, there is shown a second preferred embodiment of the flexible cable of the present invention. The spacing means 231 includes a continuous train of interleaved and convoluted protrusions formed on the outer surface of the insulated outer layers.

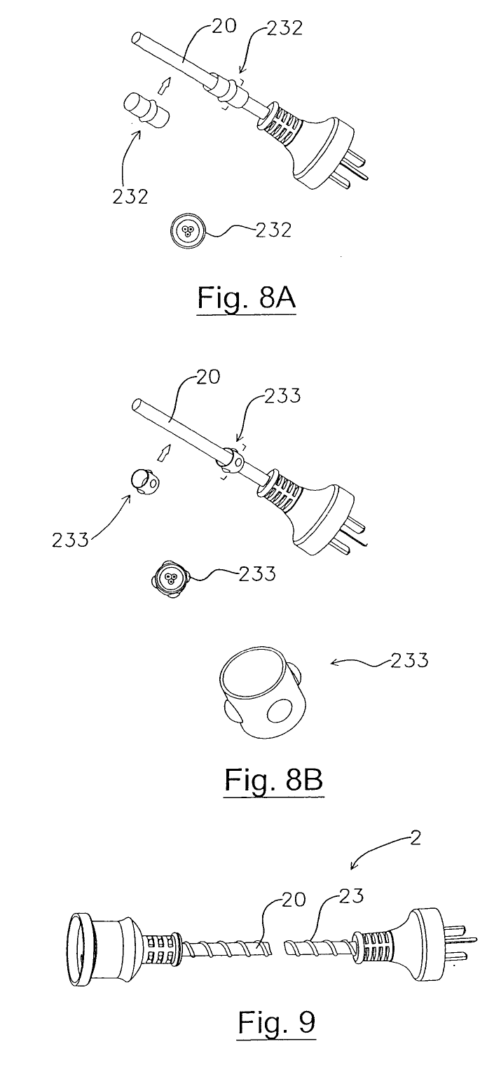

Referring to FIG. 8A, there is shown a third preferred embodiment of the flexible electric cable with the spacing means 232 including a plurality of sleeve members having a plurality ring-shaped protrusions formed on the outer surface of the sleeve.

Referring to FIG. 8B, there is shown a fourth embodiment of flexible electric cable of the present invention with the spacing means 233 including a plurality of circumferentially distributed protuberances on the outer insulated layer. Similar to the other embodiments, these protuberances will cooperate with adjacent portions of the closely wound cable to form ventilating air channels so that the adverse heat can be guided away from the interior of the cable windings. Likewise, the protuberances can be moulded onto the cable 20 or by firstly formed into sleeved members with protuberance which are then inserted and attached onto and along the cable.

Referring to FIG. 9, there is shown an extension cord 2 having a first and a second terminal connector including a length of flexible electrical cable 20 of the same type as that shown in FIGS. 1 and 2.

In the above preferred embodiments, the spacing means are attached to the outer insulated layer of the flexible electric cable by molding so that the insulated spacing means are integrally formed or attached onto the flexible cables. Of course, the spacing means can also be attached to the flexible electric cable by other appropriate means such as by gluing, by welding, by hot melting, by using heat shrinkable sleeves, by winding a continuous length of insulated spacing means about the outer insulated layer or by distributing a plurality of sleeve means along the length of the flexible cable. Typically, the effective pitch of the spacing is around 20-25 mm, so that the channel width of the air ventilating channels are also approximately between 20-25 mm, although other appropriate pitch values, for example, 60-65 mm, as in the above example can be used. Furthermore, while an electrical cable including a plurality of conductors is illustrated in the drawings, it will be appreciated that the cable can include a single conductor without loss of generality.

While the winding surface of the core portion 13 of the present preferred embodiments are generally cylindrical, it will be appreciated that non-cylindrical surfaces, for example, polygonal or even square winding surfaces can be utilized. It will also be appreciated that the present electric cable device as described above can be incorporated into other electric devices, apparatus and systems.

While the present invention has been explained by reference to the preferred embodiments described above, it will be appreciated that the embodiments are only illustrated as examples to assist understanding of the present invention and are not meant to be restrictive on its scope. In particular, the scope, ambit and spirit of this invention are meant to include the general principles of this invention as inferred or exemplified by the embodiments described above. More particularly, variations or modifications which are obvious or trivial to persons skilled in the art, as well as improvements made on the basis of the present invention, should be considered as falling within the scope and boundary of the present invention.

In addition, while the present invention has been explained by reference to a specific example of a cable reel and electric cable, it should be appreciated that the invention can apply, whether with or without modifications, to other electric cables and cable devices without loss of generality. Furthermore, it will be appreciated by persons skilled in the art that the invention can be used in conjunction with or incorporated into other electrical apparatus or appliances, such as, for example, outdoor lighting means for added benefits.

1. An electrical cable device including a cable receptacle and a length of flexible electrical cable, said cable receptacle includes a core portion around which said length of flexible electrical cable can be wound into a plurality of stacked cable layers, said electrical cable includes an outer insulated layer which surrounds one or more electrical conductors and spacing means, said spacing means are adapted to co-operatively form air space between adjacent layers of said length of flexible electrical cable when said flexible cable is being wound on said core portion, said air space being adapted to alleviate the building up of adverse heat on the wound flexible cable due to current flowing through said flexible cable.

2. A cable device of claim 1, wherein said spacing means include generally helical or spiral protrusions formed on or attached to or about the outer surface of said outer insulated layer.

3. A cable device of claim 2, wherein said helical or spiral protrusions being integrally formed or moulded with said outer insulated layer.

4. A cable device of claim 1, wherein said spacing means include convoluted protrusions formed on the outer surface of said outer insulated layer.

5. A cable device of claim 4, wherein said convoluted protrusions being integrally moulded or formed on said outer surface of said outer insulated layer.

6. A cable device of claim 1, wherein said spacing means include a plurality of ring-shaped protrusions distributed generally along the length of said flexible electrical cable.

7. A cable device of claim 1, wherein said cable receptacle being rotatable about a supporting means, said cable receptacle being rotatable in one direction to release said length of flexible cable and in another direction to retrieve said flexible cable.

8. A cable device of claim 1, wherein said spacing means co-operatively define with adjacent layers of said flexible electrical cable a plurality of ventilating air channels when said electrical wire is wound on said core portion of said receptacle, said ventilating air channels being disposed to direct hot air to exit from said wound layers of flexible cable to the outside.

9. A cable device of claim 8, wherein said ventilating channel includes an exit aperture between adjacent layers of stacked cable, said air channel and said aperture being disposed so that hot air exiting from said device will emerge at an orientation which is generally transverse to the length of said flexible electrical cable.

10. A cable device of claim 8, wherein a plurality of cable windings are formed on a cable layer, said spacing means collectively form a plurality of ventilating air channels between two adjacent layers of said flexible electrical cable when said cable is wound in the normal manner on said core portion of said receptacle.

11. A cable device of claim 8, wherein said ventilating channels on the same cable layer extend transversally between the outermost windings.

12. A cable device of claim 8, wherein said plurality of ventilating air channels on the same cable layer generally extend transversal to the length of said cable and are distributed along the perimeter of said same cable layer.

13. A cable device of claim 12, wherein said ventilating air channels are co-operatively defined by the spacing means disposed on adjacent layers of said flexible electrical cable.

14. A cable device of claim 1, wherein said core portion includes a generally cylindrical winding surface around which said length of flexible electrical cable can be wound into a plurality of generally circular stacked cable layers.

15. A cable device of claim 14, wherein said receptacle further includes a pair of guarding walls disposed on the partial ends of said cylindrical winding surface.

16. A cable device of claim 14, wherein said receptacle being rotably mounted on a supporting means.

17. A cable device of claim 16, wherein an electrical plug and an electrical pocket are connected to the ends of said flexible cable.

18. A cable device of claim 17, wherein either said electrical plug or said electrical socket is mounted on said rotatable receptacle.

19. An electrical cable device including a cable receptacle and a length of flexible electrical cable, said cable receptacle includes a core portion around which said length of flexible electrical cable can be wound into a plurality of stacked cable layers, a plurality of ventilating air channels are formed between adjacent layers of said flexible cable when said flexible cable is wound around said core portion in the normal manner, said ventilating air channels being generally transverse to the direction of winding of said flexible electrical cable.

20. A cable device of any one of the preceding claims, wherein said cable device is an electrical device commonly known as a cord reel or a cord extender reel.

21. An electrical apparatus including a cable device of any one of the preceding claims.

22. An electrical cable including an outer insulated layer, said outer insulated layer surrounds one or more insulated conductors and includes spacing means, said spacing means being adapted to co-operatively form air space between adjacent layers of said length of flexible electrical cable when said cable is wound into a plurality layers of stacked cable windings, said air space being adapted to alleviate the building up of adverse heat on the stacked cable windings due to current flowing through said cable.

23. A cable of claim 22, wherein said spacing means include generally helical, spiral or convoluted protrusions formed on the outer surface of said outer insulated layer.

24. A cable of claim 23, wherein said spacing means being molded or integrally formed on said outer insulated layer.

25. A cable of claim 24, wherein said spacing means and said outer insulated layer are both made of PVC.
